(19) United States
(12) Patent Application Publication
(10) Pub. No.: US 2014/0078115 A1
(43) Pub. Date: Mar. 20, 2014

(54) TOUCH PANEL DEVICE, DISPLAY DEVICE, TOUCH PANEL DEVICE CALIBRATION METHOD, PROGRAM, AND RECORDING MEDIUM

(71) Applicant: Makoto Itsuki, Osaka-shi (JP)

(72) Inventor: Makoto Itsuki, Osaka-shi (JP)

(73) Assignee: SHARP KABUSHIKI KAISHA, Osaka-shi, Osaka (JP)

(21) Appl. No.: 14/116,418

(22) PCT Filed: Jan. 18, 2012
(86) PCT No.: PCT/JP2012/050916

§ 371 Date: Nov. 8, 2013

(30) Foreign Application Priority Data
May 13, 2011 (JP) 2011-108787

(51) Int. Cl. G06F 3/041

(52) U.S. Cl. CPC G06F 3/0418
USPC 345/178

(57) ABSTRACT

A touch panel device (50) in accordance with the present invention includes: a detecting section (51) which detects, in accordance with a change in capacitance of a touch panel (40), an input operation conducted with respect to the touch panel (40); a calibration section (53) which calibrates a capacitance of the touch panel (40); and a determination section (54) which determines whether or not the change in capacitance in a region outside an input accepting region of the touch panel (40) is equal to or more than a predetermined amount.

### TECHNICAL FIELD

The present invention relates to a touch panel device which detects an input operation conducted with respect to a touch panel.

### BACKGROUND ART

In recent years, more and more touch panels have been employed, as input means via which a user conducts operations, for electronic apparatuses, such as a mobile terminal and a PDA. A touch panel is an input device which outputs a signal which varies depending on a touched position, in a case where a user's finger touches the touch panel. Examples of a method for detecting the touched position include a resistive method and a capacitive method.

FIG. 6 schematically illustrates a configuration of a general capacitive touch panel 100. The touch panel 100 includes m sense lines SL1 to SLm, n drive lines DL1 to DLn, m×n capacitors C11 to Cmn, n amplifiers AMP1 to AMPn, and n feedback capacitors Cf1 to Cfn. The feedback capacitors Cf1 to Cfn are provided to respective negative feedback circuits of the amplifiers AMP1 to AMPn. The drive lines DL1 to DLn and the sense lines SL1 to SLm are provided in a lattice pattern, and the capacitors C11 to Cmn are provided at respective intersections of the sense lines SL1 to SLm and the drive lines DL1 to DLn. The sense lines SL1 to SLm are connected to respective inverting input terminals of the amplifiers AMP1 to AMPn. Non-inverting input terminals of the amplifiers AMP1 to AMPn are connected to a ground.

In a case where voltages hi1 (V) to him (V) are sequentially applied to the respective drive lines DL1 to DLn, an electric charge is stored in each of the capacitors C11 to Cmn. In a case where a finger becomes closer to the touch panel 100, a capacitance of a corresponding capacitor changes, so that a current value of a sense line connected to the corresponding capacitor changes. With this, it is possible to detect a change in capacitance of each of the capacitors C11 to Cmn by reading out outputs of the amplifiers AMP1 to AMPn.

FIG. 7 illustrates a distribution of capacitances of respective capacitors (hereinafter, merely referred to as “capacitance”) which capacitances are detected in accordance with an output of a touch panel. In a case where a finger becomes closer to the touch panel, a change in capacitance occurs. Therefore, it is possible to detect a touched position in accordance with a coordinate indicative of a peak of the change in capacitance.

As illustrated in FIG. 7, the distribution of the capacitances is even in a region which the finger does not touch. However, according to an actual touch panel, the distribution of the capacitances is uneven due to unevenness of a panel shape, variation in capacitances, and the like, even while nothing is touching the touch panel (see FIG. 8). In this case, sensitivity of the touch panel is ununiform. Therefore, even in a case where the finger becomes closer to the touch panel, it is difficult to read out the peak of the change in capacitance.

In view of this, a technique of carrying out a sensitivity calibration has been suggested so as to accurately detect the touched position (for, example, Patent Literature 1). Specifically, the touched position is detected in accordance with a calibrated output obtained by subtracting, from an output value of the touch panel, the distribution of the capacitances while nothing is touching the touch panel.

For example, in a case where a value indicative of a distribution identical to the distribution illustrated in FIG. 8 is subtracted from an output indicative of the distribution illustrated in FIG. 8, it is possible to obtain a calibrated output indicative of a flat distribution in a state where nothing touches the touch panel, as illustrated in (a) of FIG. 9. In a case where a touch operation is conducted after the calibration is carried out, it is possible to accurately detect a touched position because a distribution of capacitances in a region other than the touched position is flat as illustrated in (b) of FIG. 9.

The distribution of the capacitances of the touch panel changes depending on a temperature change, an environmental change, and the like. Therefore, it is necessary to regularly carry out the sensitivity calibration at a manufacturing time, at an application of electric power, and the like. Further, since the distribution of the capacitances changes in a case where a finger becomes closer to the touch panel, Patent Literature 1 describes that the sensitivity calibration is carried out in a state where a finger is not close to the touch panel.

### CITATION LIST

### Patent Literature 1

Japanese Patent Application Publication, Tokukai, No. 2010-257046 A (Publication Date: Nov. 11, 2010)

### SUMMARY OF INVENTION

### Technical Problem

However, according to such a conventional configuration, a problem occurs that a touch operation cannot be conducted while an object such as a finger is touching a region outside an input accepting region.

For example, according to an operation screen of a mobile terminal illustrated in FIG. 10, it is possible to select an object displayed with an icon in an input accepting region RE enclosed by a dashed line, by conducting a touch operation with respect to the input accepting region RE. However, in a state where an object such as a finger touches a region outside the input accepting region RE, for example, a region RN at a left side of the operation screen, the object may not be selected even though the touch operation is conducted with respect to the input accepting region RE.

FIG. 11 illustrates a distribution of capacitances of a touch panel in a state where a finger touches the region RN of the operation screen illustrated in FIG. 10. In this state, it is difficult to detect a peak of a change in capacitance even in a case where a touch operation is conducted with respect to the input accepting region RE of the operation screen illustrated in FIG. 10 because the distribution of the capacitances is uneven.

Particularly, when the mobile terminal is operated, the region RN illustrated in FIG. 10 is often unintentionally touched by a finger holding the mobile terminal. Therefore, depending on use condition, a problem frequently occurs that the touch operation with respect to the input accepting region RE cannot be detected although an apparatus is not broken down.

The present invention has been made in view of the above problems, and an object of the present invention is to provide a touch panel device and a calibration method of a touch panel, each of which allows an input operation to be accurately detected, irrespective of a state in a region outside an input accepting region of a touch panel.

### Solution to Problem

In order to attain the above object, a touch panel device in accordance with the present invention includes: detecting means for detecting, in accordance with a change in state of a touch panel, an input operation conducted with respect to the touch panel; calibration means for carrying out calibration with respect to the state of the touch panel; and determination means for determining whether or not the change in state in a region outside an input accepting region of the touch panel is equal to or more than a predetermined amount, the calibration means carrying out the calibration, in a case where the determination means determines that the change in state in the region outside the input accepting region is equal to or more than the predetermined amount.

According to the above configuration, in a case where the determination means determines that the change in state in the region outside the input accepting region, which change is due to a touch of a finger in the region outside the input accepting region of the touch panel, is equal to or more than the predetermined amount, the calibration means carries out the calibration with respect to the state of the touch panel. This allows the detecting means to accurately detect the input operation conducted with respect to the input accepting region. Therefore, it is possible to realize a touch panel device capable of accurately detecting an input operation, irrespective of a state in a region outside an input accepting region of a touch panel.

In order to attain the above object, a calibration method of a touch panel device in accordance with the present invention includes the steps of: (a) detecting, in accordance with a change in state of a touch panel, an input operation conducted with respect to the touch panel; (b) determining whether or not the change in state in a region outside an input accepting region of the touch panel is equal to or more than a predetermined amount, (c) carrying out calibration with respect to the state of the touch panel in a case where it is determined that the change in state in the region outside the input accepting region is equal to or more than the predetermined amount.

According to the above configuration, in a case where it is determined that the change in state in the region outside the input accepting region, which change is due to a touch of a finger in the region outside the input accepting region of the touch panel, is equal to or more than the predetermined amount, the calibration is carried out with respect to the state of the touch panel in the step (c). This allows the input operation conducted with respect to the input accepting region to be accurately detected in the step (a). Therefore, it is possible to realize a calibration method of a touch panel device which method allows an input operation to be accurately detected, irrespective of a state in a region outside an input accepting region of a touch panel.

### Advantageous Effects of Invention

As described above, a touch panel device in accordance with the present invention includes: detecting means for detecting, in accordance with a change in state of a touch panel, an input operation conducted with respect to the touch panel; calibration means for carrying out calibration with respect to the state of the touch panel; and determination means for determining whether or not the change in state in a region outside an input accepting region of the touch panel is equal to or more than a predetermined amount, the calibration means carrying out the calibration, in a case where the determination means determines that the change in state in the region outside the input accepting region is equal to or more than the predetermined amount. Further, a calibration method of a touch panel device in accordance with the present invention includes the steps of: (a) detecting, in accordance with a change in state of a touch panel, an input operation conducted with respect to the touch panel; (b) determining whether or not the change in state in a region outside an input accepting region of the touch panel is equal to or more than a predetermined amount, (c) carrying out calibration with respect to the state of the touch panel in a case where it is determined that the change in state in the region outside the input accepting region is equal to or more than the predetermined amount. Therefore, it is possible to realize a touch panel device and a calibration method of a touch panel device, each of which allows an input operation to be accurately detected, irrespective of a state in a region outside an input accepting region of a touch panel.

### BRIEF DESCRIPTION OF DRAWINGS

FIG. 1 is a block diagram schematically illustrating a configuration of a mobile terminal in accordance with an embodiment of the present invention.

FIG. 2 is a block diagram illustrating a configuration of a touch panel device of the mobile terminal.

FIG. 3 is a flowchart illustrating how calibration is carried out in the embodiment of the present invention.

FIG. 4 is a view illustrating distributions of capacitances of the touch panel which are detected by a detecting section of the touch panel device. (a) of FIG. 4 illustrates a distribution in a case where electric power is applied. (b) of FIG. 4 illustrates a distribution after calibration is carried out.

FIG. 5 is a view illustrating distributions of capacitances of the touch panel which are detected by the detecting section of the touch panel device. (a) of FIG. 5 illustrates a distribution while an object such as a finger is touching a region outside an input accepting region. (b) of FIG. 5 illustrates a distribution after calibration is carried out.

FIG. 6 is a view schematically illustrating a configuration of a general capacitive touch panel.

FIG. 7 is a view illustrating a distribution of capacitances of a touch panel in a state where a touch operation is carried out.

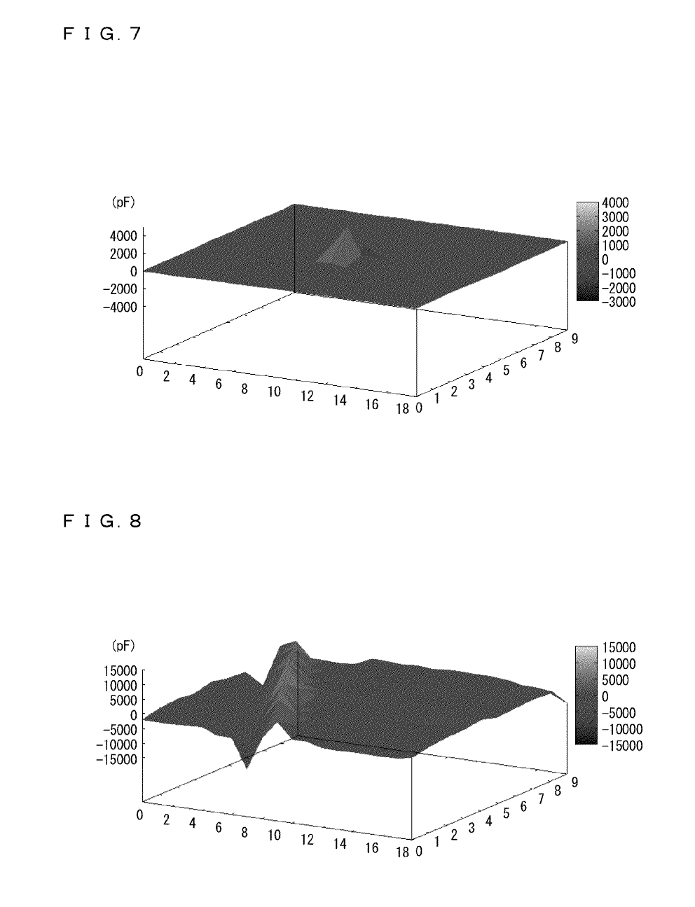

FIG. 8 is a view illustrating a distribution of capacitances of a touch panel before calibration is carried out.

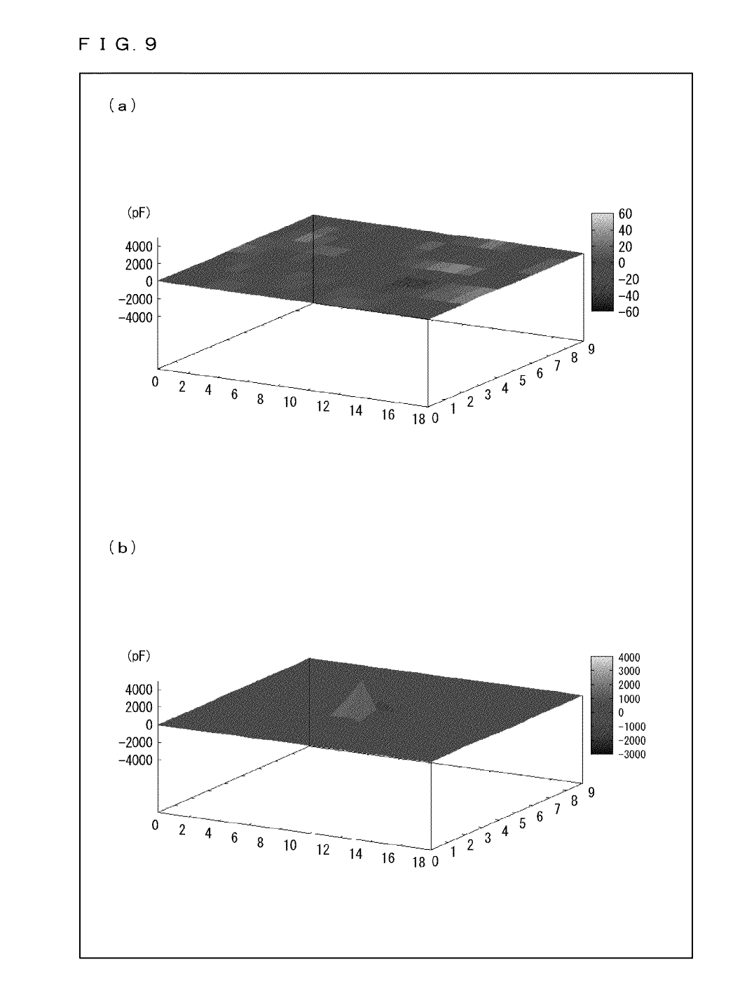

(a) of FIG. 9 is a view illustrating a distribution of capacitances of the touch panel after the calibration is carried out. (b) of FIG. 9 is a view illustrating a distribution of capacitances of the touch panel in a case where a touch operation is conducted in a state as illustrated in (a) of FIG. 9.

FIG. 10 is a view illustrating an example of an operation screen of a mobile terminal.

FIG. 11 is a view illustrating a distribution of capacitances of the touch panel while an object such as a finger is touching a region outside an input accepting region.

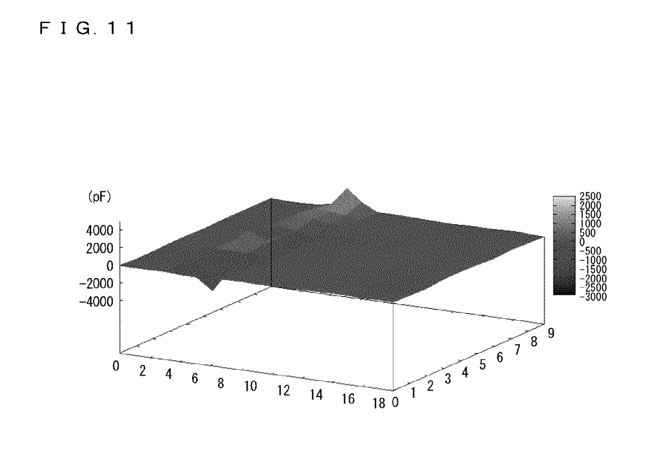

### DESCRIPTION OF EMBODIMENTS

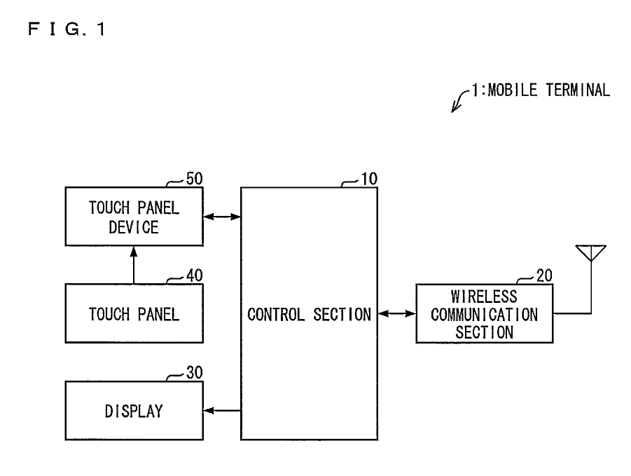

The following description will discuss, with reference to FIGS. 1 to 5, an embodiment of the present invention.

(Configuration of Mobile Terminal)

FIG. 1 is a block diagram schematically illustrating a configuration of a mobile terminal 1 in accordance with the present embodiment. The mobile terminal 1 includes a control section 10, a wireless communication section 20, a display 30, a touch panel 40, and a touch panel device 50.

The control section 10 controls various functions of the mobile terminal 1. Such various functions encompass controlling of executing applications, controlling of transmitting and receiving data by the wireless communication section 20, and controlling of displaying an image on the display 30.

The wireless communication section 20 serves to transmit/receive data to/from an external apparatus, respectively, by wireless.

Suitable examples of the display 30 encompass flat displays such as a liquid crystal display, an EL display, and a plasma display, from the perspective that the mobile terminal 1 is made flat.

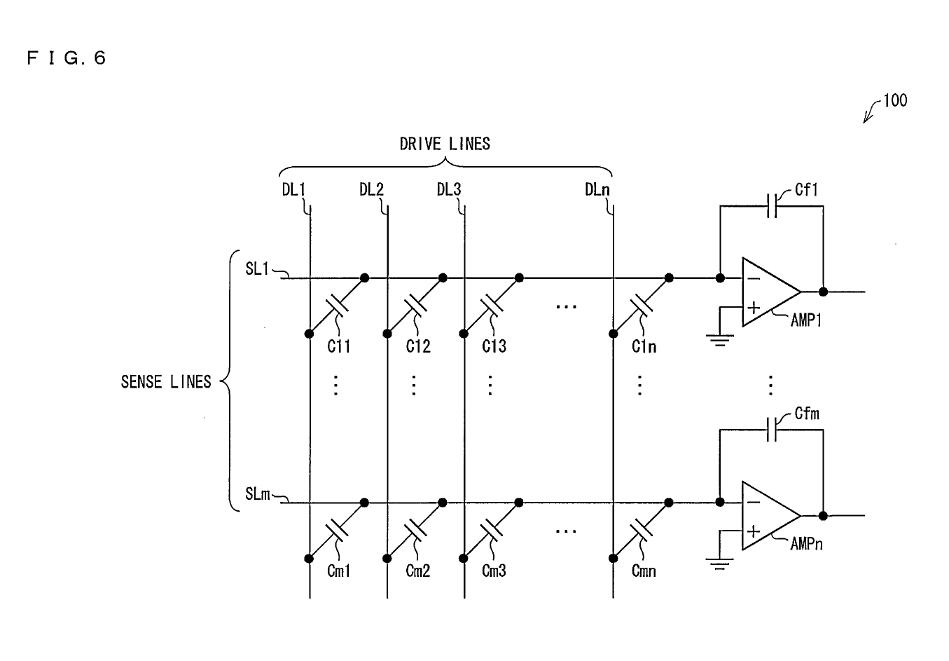

The touch panel 40 is an input apparatus via which a touch operation is conducted on a display screen of the display 30. Upon receipt of the touch operation, the touch panel 40 supplies, to the touch panel device 50, a signal which varies depending on a touched position. According to the present embodiment, a capacitive touch panel is employed as the touch panel 40. Note that the touch panel 40 can have a configuration substantially identical to that of the touch panel 100 (see FIG. 6).

The touch panel device 50 detects, in accordance with the signal supplied from the touch panel 40, an input operation conducted with respect to the touch panel 40, and then supplies, to the control section 10, content of the input operation thus detected. Note that a state of the touch panel 40 changes depending on the environment. This causes an output of the touch panel 40 to vary. In view of the circumstances, the touch panel device 50 functions to calibrate the state of the touch panel 40 (sensitivity calibration) so as to accurately detect a touched position.

(Configuration of Touch Panel)

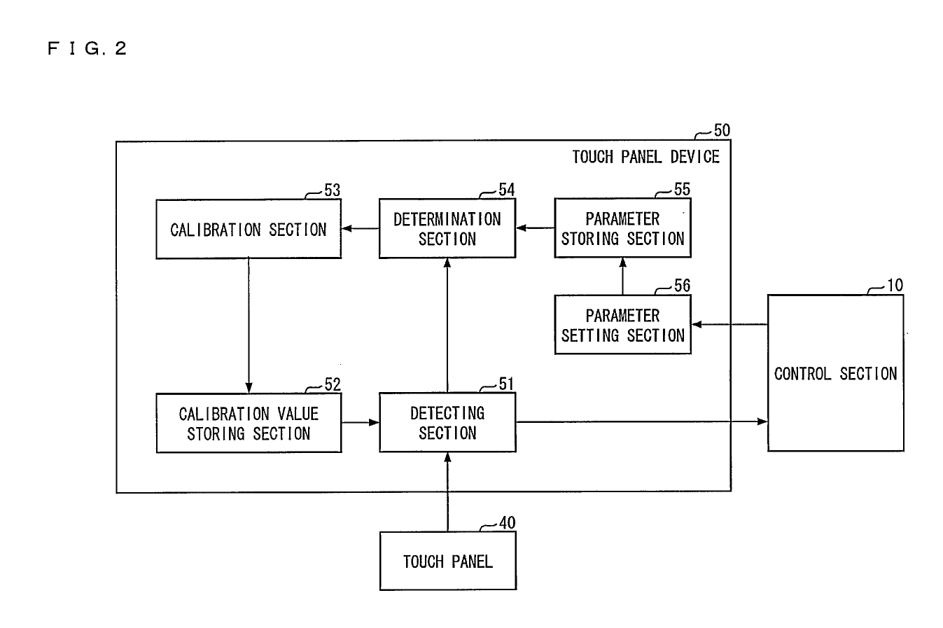

FIG. 2 is a block diagram illustrating a configuration of the touch panel device 50. The touch panel device 50 includes a detecting section 51, a calibration value storing section 52, a calibration section 53, a determination section 54, a parameter storing section 55, and a parameter setting section 56.

The detecting section 51 serves to detect, in accordance with an output of the touch panel 40, the input operation conducted with respect to the touch panel 40. More specifically, the detecting section 51 detects, as a touched position, a position at which the touch panel 40 has a peak of a change in capacitance, and then supplies a value indicative of the touched position to the control section 10 and the determination section 54.

The calibration value storing section 52 is a memory for storing therein a calibration value which allows the detecting section 51 to accurately detect the touched position, irrespective of the state of the touch panel 40 (variation in capacitances). The detecting section 51 outputs a value obtained by subtracting, from the output of the touch panel 40, the calibration value stored in the calibration value storing section 52.

The calibration section 53 serves to calibrate the state of the touch panel 40. Specifically, the calibration section 53 causes the calibration value storing section 52 to store, as a new calibration value, capacitances obtained during calibration. For example, when the calibration is carried out in a state where nothing touches the touch panel 40, capacitances in such a non-touch state are stored, as a calibration value, in the calibration value storing section 52. A value obtained by subtracting the calibration value from the output of the touch panel 40 indicates a change in capacitance from the non-touch state. It is therefore possible for the detecting section 51 to accurately detect a touched position.

The determination section 54 determines whether or not the calibration section 53 needs to carry out calibration. Specifically, the determination section 54 determines whether or not the calibration section 53 needs to carry out calibration, in accordance with whether or not a change in state, that is, a change in capacitance in a region outside an input accepting region of the touch panel 40 is equal to or more than a predetermined amount, with reference to reference values (parameters) stored in the parameter storing section 55. As used herein, the term “input accepting region” means a region in which an input operation, conducted with respect to an apparatus including a touch panel 40, can be effectively accepted. Examples of the input accepting region include a region in which an operation, such as selection of an icon, enlargement and reduction of a screen, and scroll of a screen, can be accepted.

The parameter storing section 55 is a memory in which the parameters are stored on the basis of which the determination section 54 determines whether or not calibration needs to be carried out. The parameter storing section 55 stores, as the parameters, (i) input accepting region information, (ii) touch area information, and (iii) touch duration time information on how long the touch panel 40 has been touched.

The determination section 54 instructs the calibration section 53 to carry out the calibration, in a case where (i) a touch area, in which the change in capacitance occurs, is equal to or more than a value indicated by the touch area information and (ii) a touch duration time is equal to or more than a value indicated by the touch duration time information (described later).

The parameter setting section 56 serves to change each of the parameters stored in the parameter storing section 55 and set the each of the parameters thus changed. For example, in a case where (i) a change in parameter is accepted, via a screen for setting the parameters, while the display 30 is displaying such a screen, the parameter setting section 56 changes each of the parameters of the touch area information and the touch duration time information. Note that the input accepting region varies depending on a screen. As such, every time a screen displayed on the display 30 is switched to another screen, the parameter setting section 56 sets, in accordance with information supplied from the control section 10, the input accepting region information indicative of an input accepting region of the another screen, and then causes the parameter storing section 55 to store the input accepting region information thus newly set. This causes the input accepting region information, stored in the parameter storing section 55, to be automatically updated with a value indicative of the input accepting region which varies depending on a screen displayed on the display 30.

According to the present embodiment, the value indicative of the touch area information is set to 1 cm², and the value indicative of the touch duration time information is set to 2 seconds. Specifically, the determination section 54 instructs the calibration section 53 to carry out the calibration, in a case where (i) the touch operation is detected in the region outside the input accepting region of the touch panel 40, (ii) the touch area is equal to or more than a predetermined area (1 cm²), and (iii) the touch duration time is equal to or more than a predetermined time period (2 seconds).

Note that each of the parameters stored in the parameter storing section 55 can (i) be rewritable by a user of the mobile terminal 1 or (ii) be set at a manufacturing time of the mobile terminal 1 and thereafter not be allowed to be rewritten.

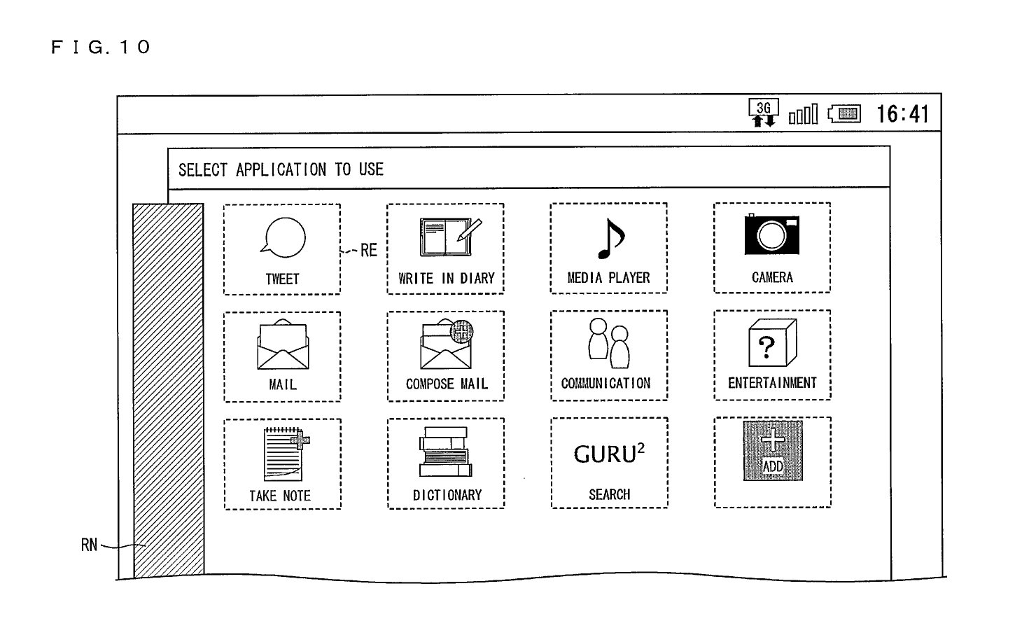

For example, as illustrated in FIG. 10, in a case where an object such as a finger is touching the region RN outside the input accepting region RE for the predetermined time period, the calibration is carried out, and capacitances obtained while the finger is touching the region RN is stored, as the calibration value, in the calibration value storing section 52. Note that an output of the detecting section 51 is obtained by subtracting the calibration value from the output of the touch panel 40. Accordingly, even while the object such as a finger is touching the region RN, the detecting section 51 outputs a signal indicative of an even distribution of the capacitances. It is therefore possible for detecting section 51 to accurately detect the touch operation conducted by a user, in a case where the touch operation is conducted with respect to the input accepting region RE while the object such as a finger is touching the region RN.

(Process of Calibration)

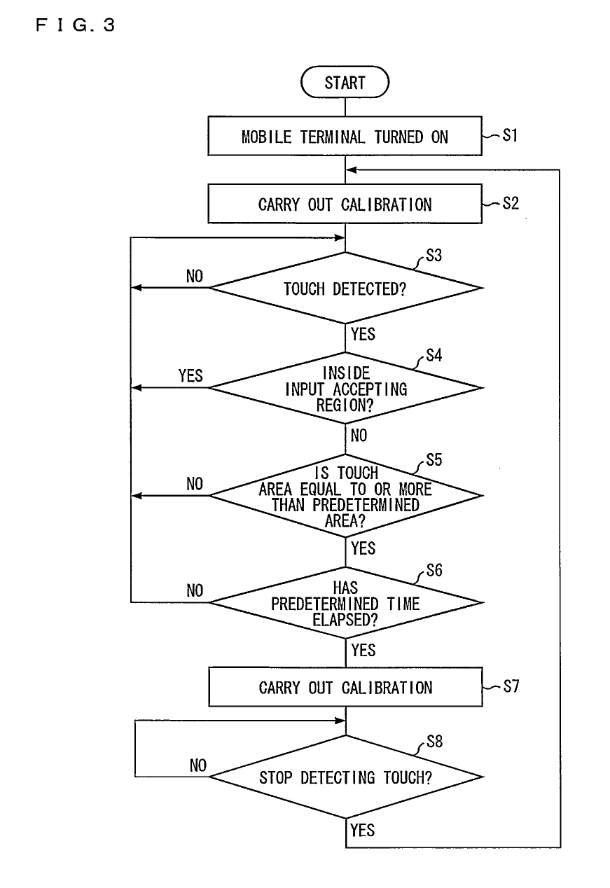

Next, the following description will discuss, with reference to FIGS. 3 to 5, how the calibration is carried out by the calibration section 53.

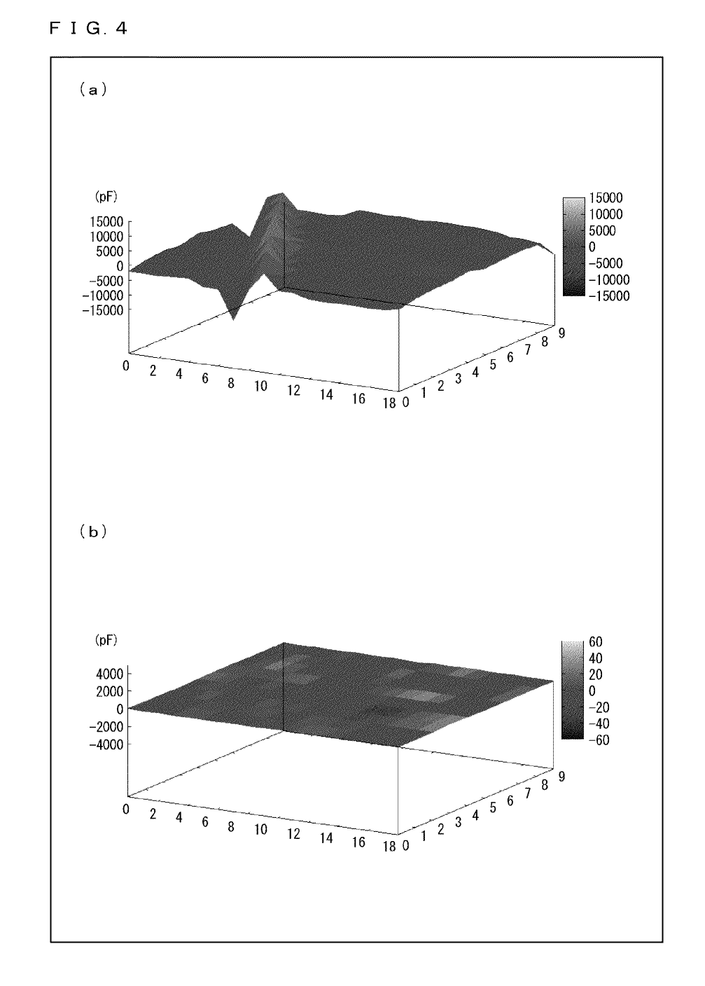

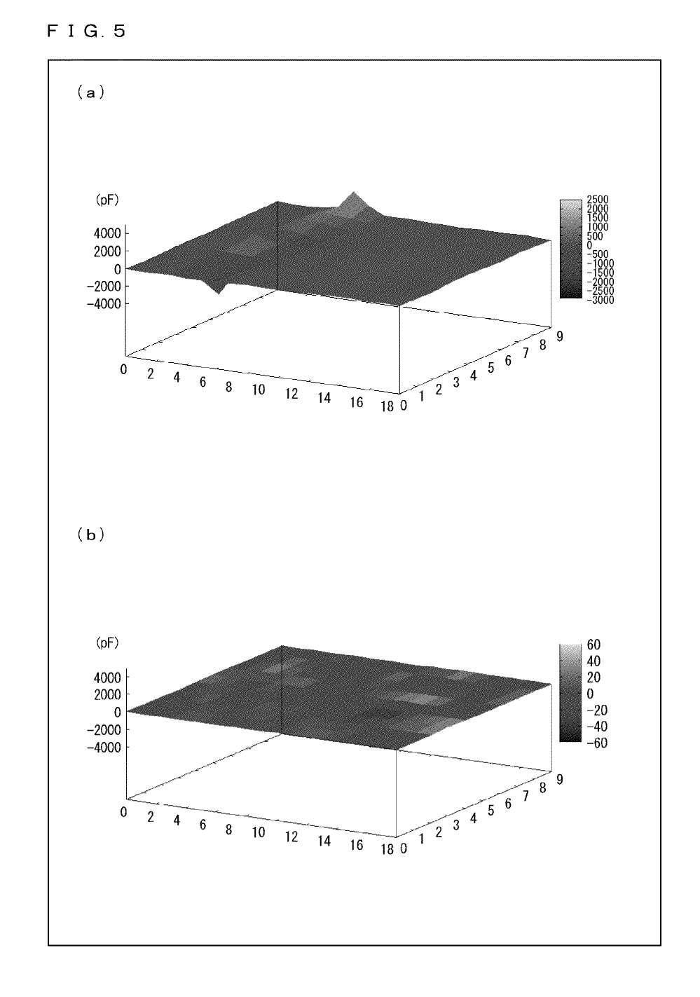

FIG. 3 is a flowchart illustrating how the calibration is carried out in the present embodiment. Each of FIGS. 4 and 5 is a view illustrating a distribution of the capacitances of the touch panel 40 which are detected by the detecting section 51.

As illustrated in FIG. 3, in a case where the mobile terminal 1 is turned on (step S1), the calibration section 53 carries out calibration (step S2). This causes the distribution of the capacitances, detected by the detecting section 51, to be calibrated, for example, from a distribution illustrated in (a) of FIG. 4 to a distribution illustrated in (b) of FIG. 4.

Thereafter, in a case where a touch operation is detected (Yes, in step S3), the determination section 54 determines whether or not a touched position is inside the input accepting region of the touch panel 40, with reference to the input accepting region information stored in the parameter storing section 55 (step S4). In a case where the touched position is outside the input accepting region of the touch panel 40 in the step S4 (No, in step S4), the determination section 54 determines, with reference to the touch area information stored in the parameter storing section 55, whether or not a touch area is equal to or more than the predetermined area (step S5). In a case where the touch area is equal to or more than the predetermined area in step S5 (Yes, in step S5), the determination section 54 determines, with reference to the touch duration time information stored in the parameter storing section 55, whether or not a predetermined time has elapsed while the touch panel 40 is being touched (step S6). In a case where the predetermined time has elapsed while the touch panel 40 is being touched in the step S6 (Yes, in step S6), the determination section 54 instructs the calibration section 53 to carry out the calibration, and the calibration section 53 carries out the calibration (step S7).

This causes the distribution of the capacitances, detected by the detecting section 51, to be calibrated, for example, from a distribution illustrated in (a) of FIG. 5 to a distribution illustrated in (b) of FIG. 5. Therefore, even while the object such as a finger is touching the region outside the input accepting region, it is possible to conduct an input operation with respect to the input accepting region without any trouble.

Note that (i) the step S3 corresponds to a detection step recited in Claims, (ii) the steps S4 through S6 correspond to a determination step recited in Claims, and (iii) the step S7 corresponds to a calibration step recited in Claims.

Thereafter, in a case where the object such as a finger, which touched the region outside the input accepting region, detaches from the touch panel 40, the detecting section 51 stops detecting the touch (Yes, in step S8). This causes a distribution of the capacitances, detected by the detecting section 51, to change to a distribution to which the distribution illustrated in (a) of FIG. 5 is inverted. In this state, even though the touch operation is conducted with respect to the input accepting region, it is difficult to read out the peak of the change in capacitance.

Also in this case, the determination section 54 determines that a change in state in the region outside the input accepting region is equal to or more than a predetermined amount, and instructs the calibration section 53 to carry out the calibration. The calibration section 53 thus carries out calibration (step S2), and a distribution of the capacitances detected by the detecting section 51 changes again to an even distribution as illustrated in (b) of FIG. 5.

(Specific Examples of Parameters)

Regarding the parameters on the basis of which the determination section 54 determines whether or not the calibration needs to be carried out, the touch area is set to 1 cm², and the touch duration time is set to 2 seconds. Note, however, that values of the parameters are not limited to such. The touch area is preferably set to a minimum value of a touch area assumed in a case where the object such as a finger unintentionally touches the region outside the input accepting region. Similarly, the touch duration time is preferably set to a minimum value of a touch duration time assumed in a case where the object such as a finger unintentionally touches the region outside the input accepting region. Note that such parameters can be set as appropriate in accordance with a size of a user's finer and/or a shape of the mobile terminal 1.

With the configuration, no calibration is carried out, even in a case where the change in capacitance is detected in the region outside the input accepting region, for example, in a case where an object (e.g., dust), small enough not to affect detection of the touch operation in the input accepting region, touches the touch panel 40 or in a case where the object such as a finger momentarily touches the touch panel 40. It is therefore possible to prevent unnecessary calibration.

Note that examples of the parameters, on the basis of which the determination section 54 determines whether or not the calibration needs to be carried out, encompass touch number information indicative of the number of places, in the region outside the input accepting region, at each of which places a change in state is detected. In this case, calibration can be carried out, in a case where touch number is equal to or more than a predetermined number. The touch number (for example, three), which is not usually detected in a case of a usual input operation, is set as the predetermined number.

(Implementation of the Present Invention by Software)

The touch panel device 50 in accordance with the present embodiment can be configured by hardware logic. Alternatively, at least a part of functions of the touch panel device 50 can be realized by software configuration by use of a CPU as below.

That is, the touch panel device 50 includes: (i) a CPU (Central Processing Unit) which executes a command of a control program that carries out each of the functions of the touch panel device 50; (ii) a ROM (Read Only Memory) in which the program is stored; (iii) a RAM (Random Access Memory) which extracts the program in executable form; and (iv) a storage device (a recording medium) such as a memory in which the program and various sets of data are stored. The object of the present invention can be attained by (i) supplying, to the touch panel device 50, a recording medium in which program codes (an executable program, an intermediate code program, and a source program) of the program of the touch panel device 50, which is software that carries out each of the functions, are computer-readably recorded and (ii) causing a computer (or a CPU or an MPU) of the touch panel device 50 to read and carry out the program codes recorded in the recording medium.

Examples of the recording medium include: (i) tapes such as a magnetic tape and a cassette tape; (ii) disks including magnetic disks, such as a Floppy (Registered Trademark) disk and a hard disk, and optical disks, such as a CD-ROM, a CD-R, an MO, an MD, a BD, and a DVD; (iii) cards such as an IC card (including a memory card) and an optical card; and (iv) semiconductor memories realized by a mask ROM, EPROM, EEPROM, a flash ROM, and the like.

Further the touch panel device 50 can be connected to a communication network so that the program codes can be supplied to the touch panel device 50 via the communication network. This communication network is not limited to any particular one. Examples of the communication network include the Internet, an intranet, an extranet, a LAN, ISDN, VAN, a CATV communications network, a virtual private network, a telephone network, a mobile telecommunications network, and a satellite communication network. Further, a transmission medium by which the communication network is constituted is not limited to any particular one. Examples of the transmission medium include: wired transmission media such as IEEE1394, a USB, a power-line carrier, a cable TV circuit, a telephone line, and ADSL; and wireless transmission media such as infrared communication systems such as IrDA and a remote control, Bluetooth (Registered Trademark), 802.11 wireless communication system, HDR, a mobile phone network, a satellite circuit, and a digital terrestrial network.

### SUMMARY OF EMBODIMENT

A touch panel device in accordance with the above embodiment is configured such that calibration is carried out at application of electric power and in a case where (i) a touch operation is detected in a region outside an input accepting region of a touch panel and (ii) a touch area and a touch duration time are equal to or more than respective predetermined values. However, a condition on which the calibration is carried out is not limited to such. For example, the calibration can be carried out at least in a case where the touch area in the region outside the input accepting region is equal to or more than a predetermined area, in a case where the touch duration time in the region outside the input accepting region is equal to or more than a predetermined time period, or in a case where touch number in the region outside the input accepting region is equal to or more than a predetermined number. Furthermore, the calibration can be carried out in a predetermined cycle, while nothing is touching the touch panel.

Further, according to the above embodiment, a touch operation in which an object such as a finger touches the touch panel is assumed as an input operation with respect to the touch panel. However, the embodiment is not limited to such. Examples of the input operation with respect to the touch panel include a hover operation in which the input operation is conducted in a case where the object such as a finger becomes closer to the touch panel.

Further, the above embodiment has described a case where the touch panel is a capacitive touch panel. However, the embodiment is not limited to such. As the touch panel, the other types of touch panel, such as a resistive touch panel, an ultrasonic touch panel, an infrared touch panel, and an electromagnetic induction touch panel, can be employed.

The present invention is not limited to the description of the above embodiment, but may be altered by a skilled person within the scope of the claims. An embodiment derived from a proper combination of technical means disclosed in different embodiments is also encompassed in the technical scope of the present invention.

[Outline of Points]

As has been described, the touch panel device in accordance with the embodiment of the present invention is preferably arranged such that the determination means determines that the change in state in the region outside the input accepting region is equal to or more than the predetermined amount, in a case where an area, in the region outside the input accepting region, in which area the change in state is detected is equal to or more than a predetermined area.

The touch panel device in accordance with the embodiment of the present invention is preferably arranged such that the determination means determines that the change in state in the region outside the input accepting region is equal to or more than the predetermined amount, in a case where the change in state has been detected, in the region outside the input accepting region, for a predetermined time period.

The touch panel device in accordance with the embodiment of the present invention is preferably arranged such that the determination means determines that the change in state in the region outside the input accepting region is equal to or more than the predetermined amount, in a case where the number of places, in the region outside the input accepting region, at each of which places the change in state is detected is equal to or more than a predetermined number.

According to the above configuration, in a case where the area, in the region outside the input accepting region, in which area the change in state of a touch panel is detected is equal to or more than the predetermined area, in a case where the change in state of the touch panel has been detected, in the region outside the input accepting region, for the predetermined time period, or in a case where the number of the places, in the region outside the input accepting region, at each of which places the change in state of the touch panel is detected is equal to or more than the predetermined number, the calibration is carried out. Therefore, it is possible to avoid a disadvantage that an input operation cannot be detected in such a case where a finger unintentionally touches the region outside the input accepting region.

The touch panel device in accordance with the embodiment of the present invention is preferably arranged such that the determination means includes setting means for (i) changing a reference value on the basis of which the determination means carries out the determination and (ii) setting the reference value thus changed.

According to the above configuration, it is possible to set a condition as appropriate on which the calibration is carried out, in accordance with a size of a user's finer and/or a shape of a mobile terminal including the touch panel device.

A display device in accordance with the embodiment of the present invention includes a display for displaying an image, a touch panel provided on the display, and a touch panel device for detecting an input operation conducted with respect to the touch panel, the touch panel device being a touch panel device described above.

The calibration method of a touch panel device in accordance with the embodiment of the present invention is preferably arranged such that it is determined, in the determination step, that the change in state in the region outside the input accepting region is equal to or more than the predetermined amount, in a case where an area, in the region outside the input accepting region, in which area the change in state is detected is equal to or more than a predetermined area.

The calibration method of a touch panel device in accordance with the embodiment of the present invention is preferably arranged such that it is determined, in the determination step, that the change in state in the region outside the input accepting region is equal to or more than the predetermined amount, in a case where the change in state has been detected, in the region outside the input accepting region, for a predetermined time period.

The calibration method of a touch panel device in accordance with the embodiment of the present invention is preferably arranged such that it is determined, in the determination step, that the change in state in the region outside the input accepting region is equal to or more than the predetermined amount, in a case where the number of places, in the region outside the input accepting region, at each of which places the change in state is detected is equal to or more than a predetermined number.

According to the above configuration in a case where the area, in the region outside the input accepting region, in which area the change in state of the touch panel is detected is equal to or more than the predetermined area, in a case where the change in state of the touch panel has been detected, in the region outside the input accepting region, for the predetermined time period, or in a case where the number of the places, in the region outside the input accepting region, at each of which places the change in state of the touch panel is detected is equal to or more than the predetermined number, the calibration is carried out. Therefore, it is possible to avoid a disadvantage that an input operation cannot be detected in such a case where a finger unintentionally touches the region outside the input accepting region.

The touch panel device and the calibration method of a touch panel in accordance with the embodiment of the present invention can be arranged such that the touch panel is a capacitive touch panel having capacitors, and the state indicates capacitances of the respective capacitors.

According to the above configuration, the input operation conducted with respect to the touch panel is detected in accordance with a change in capacitance of each of the capacitors. In a case where a change in capacitance in the region outside the input accepting region is equal to or more than a predetermined amount, the calibration is carried out.

A program in accordance with the present invention is a program causing a touch panel device to operate, the program causing a computer to function as each means of the touch panel device.

The program is recorded in a computer readable recording medium.

### INDUSTRIAL APPLICABILITY

The present invention is applicable to not only a mobile terminal but also every display device having a touch panel.

### REFERENCE SIGNS LIST

1 Mobile terminal (display device)
10 Control section
20 Wireless communication section
30 Display
40 Touch panel
50 Touch panel device
51 Detecting section (detecting means)
52 Calibration value storing section
53 Calibration section (calibration means)
54 Determination section (determination means)
55 Parameter storing section
56 Parameter setting section (setting means)
100 Touch panel
AMP1 to AMPn Amplifiers
C11 to Cmn Capacitors
Cf1 to Cfn Feedback capacitors
DL1 to DLn Drive lines
SL1 to SLm Sense lines
RE Input accepting region

1-14. (canceled)

15. A touch panel device comprising:
detecting means for detecting, in accordance with a change in state of a touch panel, an input operation conducted with respect to the touch panel;
calibration means for carrying out calibration with respect to the state of the touch panel; and
determination means for determining whether or not the change in state in a region outside an input accepting region of the touch panel is equal to or more than a predetermined amount,
the calibration means carrying out the calibration, in a case where the determination means determines that the change in state in the region outside the input accepting region is equal to or more than the predetermined amount,
the determination means determining that the change in state in the region outside the input accepting region is equal to or more than the predetermined amount, in a case where an area, in the region outside the input accepting region, in which area the change in state is detected is equal to or more than a predetermined area.

16. A touch panel device comprising:
detecting means for detecting, in accordance with a change in state of a touch panel, an input operation conducted with respect to the touch panel;
calibration means for carrying out calibration with respect to the state of the touch panel; and
determination means for determining whether or not the change in state in a region outside an input accepting region of the touch panel is equal to or more than a predetermined amount,
the calibration means carrying out the calibration, in a case where the determination means determines that the change in state in the region outside the input accepting region is equal to or more than the predetermined amount,
the determination means determining that the change in state in the region outside the input accepting region is equal to or more than the predetermined amount, in a case where the number of places, in the region outside the input accepting region, at each of which places the change in state is detected is equal to or more than a predetermined number.

17. A touch panel device comprising:
detecting means for detecting, in accordance with a change in state of a touch panel, an input operation conducted with respect to the touch panel;
calibration means for carrying out calibration with respect to the state of the touch panel; and
determination means for determining whether or not the change in state in a region outside an input accepting region of the touch panel is equal to or more than a predetermined amount,
the calibration means carrying out the calibration, in a case where the determination means determines that the change in state in the region outside the input accepting region is equal to or more than the predetermined amount,
the determination means including setting means for (i) changing a reference value on the basis of which the determination means carries out the determination and (ii) setting the reference value thus changed.

18. The touch panel device as set forth in claim 17, wherein the determination means determines that the change in state in the region outside the input accepting region is equal to or more than the predetermined amount, in a case where the change in state has been detected, in the region outside the input accepting region, for a predetermined time period.
